(19) United States
(12) Patent Application Publication
(10) Pub. No.: US 2017/0246794 A1
(43) Pub. Date: Aug. 31, 2017

(54) METHOD FOR MAKING A GAS-TIGHT CONTAINER IN ELASTOMERIC MATERIAL

(71) Applicant: Faber Industrie S.p.A., Cividale del Friuli, Udine (IT)

(72) Inventors: Gian Luigi Cola, Cividale del Friuli (IT); Raffaele Di Sarno, Cividale del Friuli (IT); Claudio Cromaz, Cividale del Friuli (IT)

(73) Assignee: Faber Industrie S.p.A., Cividale del Friuli, Udine (IT)

(21) Appl. No.: 15/517,845

(22) PCT Filed: Oct. 7, 2015
(86) PCT No.: PCT/IB2015/057653

§ 371 Date: Apr. 7, 2017

(30) Foreign Application Priority Data
Oct. 9, 2014 (IT) MI2014A001769

(51) Int. Cl. B29C 65/48; F17C 1/00; B29C 65/82; B29C 65/00; B29C 65/50; B29C 65/78

(52) U.S. Cl. CPC B29C 65/4835; B29C 65/5057; B29C 65/7847; B29C 65/8246; B29C 65/8253; B29C 66/02245; B29C 66/1122; B29C 66/1162; B29C 66/547; B29C 66/8322; F17C 1/00; B29L 2031/7156

(57) ABSTRACT

A method for making a gas-tight container (1) in elastomeric material comprises: providing two or more separate elastomeric portions (2, 3), cleaning and/or roughening the gluing surfaces (6) of the gluing edges (5), applying an adhesive (7) onto the previously cleaned, degreased and/or roughened gluing surfaces (6), assembling the portions (2, 3) to form the container (1) and inserting between the gluing surfaces (6) a raw elastomeric tape (8) not yet cured, applying a cold pressure on the overlapped gluing edges (5), heating the overlapped gluing edges (5) to thermally activate the curing of the raw tape (8), cooling the gluing areas.

The object of the invention is a method for making a gas-tight container in elastomeric material (rubber) and a method for making a pressurized gas container.

Gas-tight containers in elastomeric material are used as inner lining of pressurized gas containers, e.g. composite material gas cylinders, where they perform the gas-tightness function, while an outer housing of the container withstands the mechanical stress deriving from the stored gas pressure. Due to the complex shape and large size of the pressurized gas containers, as well as the several different shapes and sizes of such pressure containers, the process of making such gas-tight containers in elastomeric material (inner elastomeric bladders) is still problematic with reference to obtaining the desired shapes and sizes, to tightness and the feasibility of mass making such rubber containers in a reliable, repeatable manner and in mass production.

It is thus the object of the present invention to provide a method for making a gas-tight container in elastomeric material (rubber) and a method for making a pressure container, having features so as to avoid at least in part the drawbacks of the prior art.

These and other objects are achieved by means of a method according to claim 1. The dependent claims relate to advantageous embodiments.

In order to better understand the invention and appreciate its advantages, some non-limiting, exemplary embodiments will be described below with reference to the figures, in which:

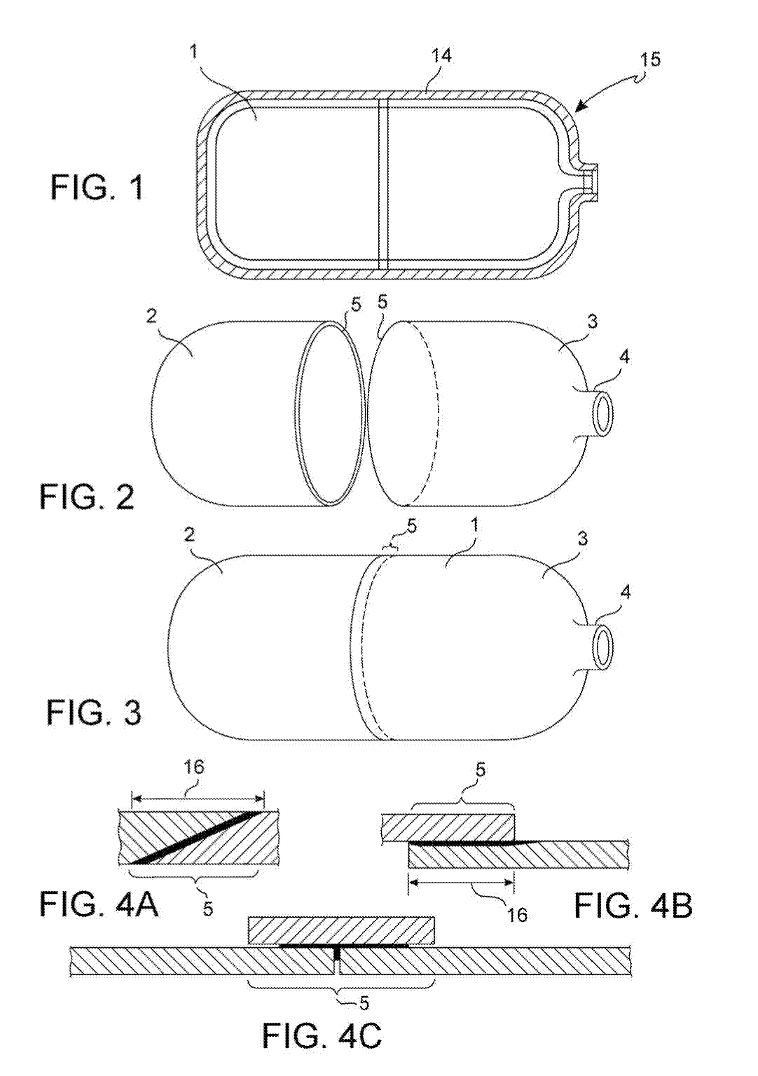

FIG. 1 is a section view of a pressure container provided with an inner lining formed by a gas-tight bladder in elastomeric material,

FIG. 2 shows two half-shells in elastomeric material, intended to be joined to form a gas-tight container, e.g. in the form of elastomeric bladder,

FIG. 3 shows a gas-tight container in elastomeric material obtained by the method according to the invention,

FIGS. 4A, 4B, 4C are section views of a gluing area of the gas-tight container in elastomeric material according to embodiments of the invention,

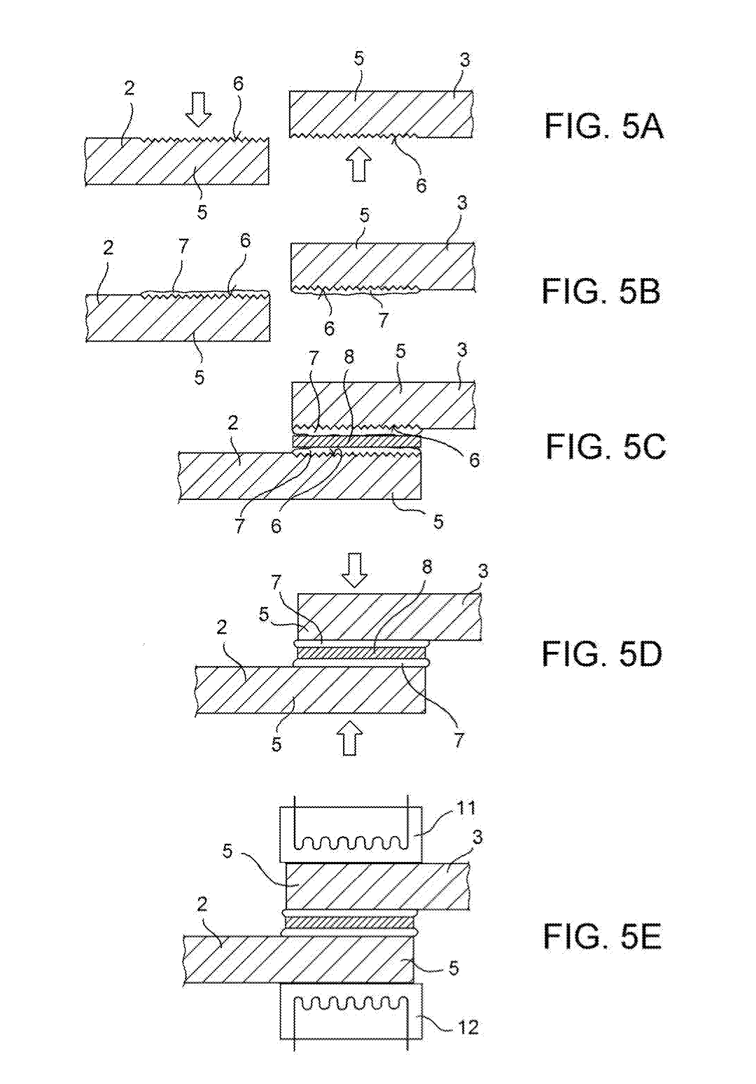

FIGS. 5A, 5B, 5C, 5D, 5E show steps of the method for making the elastomeric container according to an embodiment of the invention,

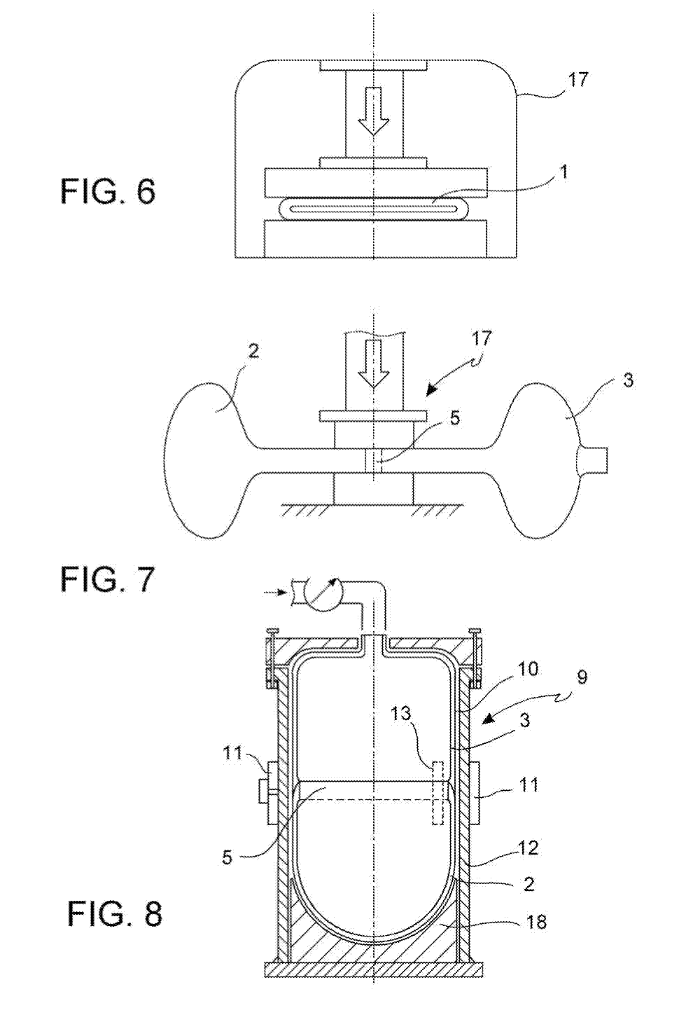

FIGS. 6 and 7 show a method step and an equipment for implementing the method step according to an embodiment,

FIG. 8 shows a further method step and equipment for implementing the further method step according to an embodiment.

With reference to the figures, a method for making a gas-tight container 1 in elastomeric material, comprises:

A) providing two or more elastomeric portions 2, 3, initially separated from each other, in the shape of an open three-dimensional shell, e.g. a bottom half-shell 2 having the shape of a cup with a closed rounded bottom and an ogival half-shell 3 having the shape of a cup with an ogival rounded bottom and boss portion 4 (FIG. 2).

The elastomeric portions 2, 3 (or, in other words, the half-bladders 2, 3) may be separately manufactured by means of injection moulding followed by curing the elastomeric material.

During the step of moulding, the gluing edges 4 may be appropriately shaped or profiled, for example as a ramp, i.e. as an oblique cutting profile with respect to the wall plane of the gluing edge 4 (FIGS. 4A . . . C), to provide a larger contact and gluing surface for the subsequent gluing operation.

B) Connecting the initially separated elastomeric portions 2, 3 by means of gluing along one or more gluing edges 5, so as to obtain the desired final shape of the elastomeric container 1.

The step of connecting the elastomeric portions 2, 3 along the gluing edges 5 may comprise:

B1) cleaning, degreasing and/or roughening the gluing surfaces 6 of the gluing edges 5, either mechanically (by grinding) or chemically (by treating with corrosive substances, e.g. acids).

Cleaning may be performed by means of isopropanol soap, methyl ethyl ketone or other chemicals. The roughening of the gluing surfaces 6 may be performed by means of grinding or plasma treatment (FIG. 5A).

B2) Applying an adhesive 7 (primer), preferably with cold-set adhesive action onto the previously cleaned, degreased and/or roughened gluing surfaces 6 (FIG. 5B).

The gluing surfaces 6 may be coated with adhesive (e.g. chloroprene) by means of a paintbrush, roller, spatula or spray. Furthermore, the uniformity of the applied primer layer can be checked by means of a visual inspection lamp (non-destructive test).

B3) Assembling the portions 2, 3 to form the container and inserting a raw elastomeric tape 8 not yet completely cured (“raw” non-vulcanized rubber) between two gluing surfaces 6, respectively, intended to be glued to each other, preferably but not necessarily of the same starting elastomeric material as the portions 2, 3 and then overlapping and gluing the two gluing surfaces 6 by means of adhesive 7 and with the interposition of the raw tape 8 (FIG. 5C).

For this purpose, it is advantageous to insert the portions 2, 3 (half-shells or half-bladders), one of which with tape 8 already applied, in a locking jig (not shown) to ensure the proper positioning of the portions 2, 3 with the proper overlapping of the gluing edges 5 intended to be connected to each other.

Furthermore, a vacuum can be applied between the jig and the polymeric portions 2, 3 in order to force container 1 to take and retain the proper overlapping geometry.

The raw tape 8 may have a thickness of 0.4 mm . . . 1.0 mm and a width of 15 mm . . . 25 mm, preferably about 20 mm.

B4) Applying a (cold) pressure to the portions 2, 3 at the overlapped gluing edges 5 with the raw tape 8 interposed therebetween in a pressure direction transversal to the wall plane of the gluing edges 5 (FIG. 5D). For this purpose, it is advantageous to insert the previously assembled portions 2, 3 into a press 17 (FIGS. 6, 7) and exert on the gluing areas 5 a pressure adapted to activate the operation of cold gluing the adhesive (primer) 7.

By way of example, press 9 may exert a force of 2000 kN (200 tons) distributed on the overlapped gluing edges 5. The pressure time is a few seconds, e.g. 3 s . . . 5 s . . . 20 s.

B5) Heating the overlapped gluing edges 5 to thermally activate the curing of tape 8, in order to provide a tight seal of the glued areas (FIG. 5E).

For this purpose, it is advantageous to insert the container 1 already cold glued during the previous pressing operation into a closed mould 9 with an inner cavity 10 having the shape of the container 1 which is glued, at least in the gluing areas along the gluing edges 5, and internally pressurizing (inflating) container 1 with a pressure ranging from 6 Bar to 9 Bar, preferably to about 7 Bar of pressure against the cavity 10 of mould 9, and heating the gluing areas (overlapped gluing edges 5) via heating means 11 (e.g. one or more electric resistors) connected to a wall 12 of cavity 10. The thermal treatment includes the application of a temperature from 110° C. to 140° C., preferably of about 130° C. for about 20-25 minutes.

Such an operation causes the curing (vulcanization) of the initially “raw” tape 8, thus ensuring a perfect tightness of the gluing edges 5 of the joined portions 2, 3.

Moreover, alternately or additionally to heating from the outside, further heating means may be positioned within the elastomeric container 1 (withheld in mould 9) at the gluing edges 5, to further improve or accelerate the curing of tape 8.

Mould 9 advantageously comprises one or more shaped inserts 18 which can be removably positioned in the inner cavity 10 so as to adjust and adapt the shape of cavity 10 to the shape of container 1.

The width 16 of the gluing zone, i.e. the width of the gluing surfaces 6, is in the range of 25 mm to 35 mm, preferably about 30 mm.

B6) Cooling the gluing areas, and

C) checking the tight seal under pressure of the glued elastomeric container 1. The glued elastomeric container 1 is then removed from mould 9, and container 1 is air-cooled. The pressure tightness test may be performed by water immersion or by means of acoustic emission or soapy liquid for searching for leaks.

The base elastomeric material of the portions 2, 3 of container 1 is advantageously a nitrile rubber, also known as Buna-N, Perbunan or NBR. This is a synthetic rubber, an acrylonitrile (ACN)-butadiene copolymer. According to the specific needs of use, other rubbers, such as polychloroprene-based rubber (neoprene rubber) or silicone-based rubber (silicone rubber) may be used.

The wall thickness of the portions 2, 3 is from 2 mm to 5 mm, preferably about 3 mm, for applications as the inner lining of pressure containers 15.

By way of non-limiting example, the overall length of container 1 may be from 500 mm to 100 mm, e.g. about 700 mm, and its diameter may be about 270 mm.

The elastomeric container 1 thus obtained by be mounted in an outer shell 14 of a pressure container 15, e.g. a gas cylinder made of composite material (type IV cylinder), in order to complete the process of making the pressure container 15.

The manufacturing method described hereto allows a greater versatility with reference to the three-dimensional shape and to the size of container 1, ensures an excellent tightness of container 1, and can be easily implemented for mass manufacturing processes.

Those skilled in art may obviously make further changes and variants to the manufacturing method according to the present invention, all without departing from the scope of protection of the invention, as defined by the following claims.

1. Method for making a gas-tight container in elastomeric material, comprising:
A) providing two or more elastomeric portions in the shape of a three-dimensional shell, initially separated from each other,
B) connecting the initially separated elastomeric portions by means of gluing along one or more gluing edges, such as to obtain the final shape of the elastomeric container,
C) checking the tight seal under pressure of the glued elastomeric container,
wherein the step B) of connecting the elastomeric portions along the gluing edges comprises:
B1) cleaning and/or roughening the gluing surfaces of the gluing edges,
B2) applying an adhesive with cold-set adhesive action onto the previously cleaned, degreased and/or roughened gluing surfaces,
B3) assembling the portions to form the container and inserting a raw elastomeric tape not yet cured or not yet completely cured between the gluing surfaces intended to be glued to each other,
B4) applying a cold pressure to the portions at the overlapped gluing edges with the raw tape interposed therebetween, wherein said pressure acts in a pressure direction transversal to the wall plane of the gluing edges,
B5) heating the overlapped gluing edges such as to then tally activate the curing of the raw tape, such as to provide a tight seal of the glued areas,
B6) cooling the gluing areas.

2. Method according to claim 1, wherein the elastomeric portions comprise a bottom half-shell having the shape of a cup with a closed rounded bottom and an ogival half-shell having the shape of a cup with an ogival rounded bottom and boss portion (4),
wherein said elastomeric portions are separately manufactured by means of injection moulding and, during the injection moulding step, the gluing edges are shaped, for example as a ramp, in order to provide gluing surfaces.

3. Method according to claim 1, wherein during the step B1) the cleaning is carried out by means of isopropanol soap or methyl ethyl ketone and the roughening of the gluing surfaces is carried out by means of grinding or plasma treatment.

4. Method according to claim 1, wherein in step B2) the gluing surfaces are coated with said adhesive, preferably a chloroprene adhesive, and the uniformity of the adhesive layer which has been applied is subsequently checked by a visual inspection lamp.

5. The method according to claim 1, wherein said raw tape is made of the same starting elastomeric material as the portions, but not yet completely cured.

6. Method according to claim 1, wherein in step B3) the polymeric portions are inserted, one of which is already provided with the raw tape, in a locking jig in order to ensure the proper positioning of the portions and the proper overlapping of the gluing edges intended to be connected to one another.

7. Method according to claim 6, comprising applying a vacuum between the jig and the polymeric portions in order to force the container to take and to retain the proper overlapping geometry in the gluing areas.

8. Method according to claim 1, wherein the step B4) comprises inserting the previously assembled portions in a press and exerting with said press a force ranging between 1500 kN and 2500 kN distributed on the overlapping gluing edges for a pressure time longer than three seconds.

9. Method according to claim 1, wherein the step B5) comprises inserting the already cold glued container in a closed mould with an inner cavity substantially having the shape of the container glued at least in the gluing areas along the gluing edges, and pressurizing internally the container by means of a pressure of 6 Bar to 9 Bar, or a pressure of about 7 Bar, against the cavity of the mould, and heating the gluing edges by means of heating means connected to a wall of the cavity at a temperature of 110° C. to 140° C., preferably of about 130° C. for a time ranging between 20 minutes and 25 minutes.

10. Method according to claim 9, comprising adjusting and adapting the shape of the cavity to the shape of the container by means of one or more shaped inserts which can be removably positioned in the inner cavity of the closed mould.

11. Method according to claim 1, wherein:
the width of the gluing surfaces ranges between 25 mm and 35 mm,
the base elastomeric material of the portions of the container is a nitrile rubber NBR or a polychloroprene-based rubber,
the wall thickness of the portions ranges between 2 mm and 5 mm.

12. A method for manufacturing a pressure container, comprising:
preparing a pressure-resistant outer shell,
making a gas-tight container in elastomeric material, by means of the steps:
A) providing two or more elastomeric portions in the shape of a three-dimensional shell, initially separated from each other,
B) connecting the initially separated elastomeric portions by means of gluing along one or more gluing edges, such as to obtain the final shape of the elastomeric container,
C) checking the tight seal under pressure of the glued elastomeric container,
wherein the step B) of connecting the elastomeric portions along the gluing edges comprises:
B1) cleaning and/or roughening the gluing surfaces of the gluing edges,
B2) applying an adhesive with cold-set adhesive action onto the previously cleaned, degreased and/or roughened gluing surfaces,
B3) assembling the portions to form the container and inserting a raw elastomeric tape not yet cured or not yet completely cured between the gluing surfaces intended to be glued to each other,
B4) applying a cold pressure to the portions at the overlapped gluing edges with the raw tape interposed therebetween, wherein said pressure acts in a pressure direction transversal to the wall plane of the gluing edges,
B5) heating the overlapped gluing edges such as to thermally activate the curing of the raw tape, such as to provide a tight seal of the glued areas,
B6) cooling the gluing areas,
mounting the elastomeric container in the outer shell.
